(19) United States
(12) Patent Application Publication
(10) Pub. No.: US 2021/0111773 A1
(43) Pub. Date: Apr. 15, 2021

(54) METHOD FOR FEEDBACK OF CORRELATION OF BEAMS IN WIRELESS COMMUNICATION SYSTEM AND USER EQUIPMENT

(71) Applicant: NTT DOCOMO, INC., Tokyo (JP)

(72) Inventors: Yuichi Kakishima, Tokyo (JP); Chongning Na, Tokyo (JP); Min Liu, Tokyo (JP); Huiling Jiang, Tokyo (JP); Satoshi Nagata, Tokyo (JP)

(73) Assignee: NTT DOCOMO, INC., Tokyo (JP)

(21) Appl. No.: 16/496,800

(22) PCT Filed: Mar. 22, 2018
(86) PCT No.: PCT/US2018/023778

§ 371 Date: Sep. 23, 2019

Related U.S. Application Data
(60) Provisional application No. 62/475,717, filed on Mar. 23, 2017.

(51) Int. Cl. H04B 7/06; H04B 7/08; H04B 7/0417; H04W 72/04; H04W 76/27

(52) U.S. Cl. CPC H04B 7/061; H04B 7/0874; H04B 7/0417; H04W 76/27; H04B 7/0632; H04W 72/046; H04W 72/042; H04B 7/0626

(57) ABSTRACT

A method of beam information feedback in a wireless communication system is disclosed including transmitting, from a base station (BS) to a user equipment (UE), reference signals using multiple beams, and transmitting, from the UE to the BS, first feedback information that indicates at least one of a first correlation level between a pair of beams within each of beam groups and a second correlation level between a pair of the beam groups. The multiple beams are grouped into the beam groups.

### TECHNICAL FIELD

The present invention generally relates to a method for feedback of correlation of beams in a wireless communication system and a user equipment that reports the correlation to a base station.

### BACKGROUND

For efficient scheduling in a wireless communication system, a transmitter (e.g., base station (BS)) shall acquire a correlation level of beams, which is observed at receiver (e.g., user equipment (UE)) sides. By acquiring the correlation level, the BS can combine beams with high correlation to provide better coverage and allocate beams with low correlation to different users to avoid inter-user interference. It was disclosed that the UE can report the beam measurement results in a grouping fashion. For example, multiple beams can be divided into several groups and reported separately.

However, it is still uncertain to the BS about the correlation level among different beams within a group or the correlation level between any beams among different beam groups.

Furthermore, in the conventional technologies, the group information is not able to indicate the correlation level feedback information used for performing flexible and smart scheduling in the BS.

Alt. 1 Rx beam set based grouping
Intra group: high or low correlation
Inter group: high or low correlation

Alt. 2 UE antenna group based grouping
Intra group: high or low correlation
Inter group: high or low correlation

The BS and UE are not able to align the knowledge of correlation level information without related feedback. In the conventional feedback design, the following are not clarified:

How to feed back the correlation level feedback information;

How to reduce the overhead of correlation level feedback and the related signaling; and

How to feed back flexibly.

### CITATION LIST

### Non-Patent Reference

[Non-Patent Reference 1] R1-1701715; 3GPP TSG RAN WG1 Meeting #88; Huawei, HiSilicon; “Beam diversity for data and control channels”
[Non-Patent Reference 2] R1-1701800, 3GPP TSG RAN WG1 Meeting #88; ZTE, ZTE Microelectronics; “UE reporting for beam management”

### SUMMARY

One or more embodiments of the present invention relate to a method for feedback of correlation of beams in a wireless communication system that includes transmitting, from a base station (BS) to a user equipment (UE), reference signals using multiple beams, and transmitting, from the UE to the BS, first feedback information that indicates at least one of a first correlation level between a pair of beams within each of beam groups and a second correlation level between a pair of the beam groups. The multiple beams are grouped into the beam groups.

One or more embodiments of the present invention relate to a UE that includes a receiver that receives reference signals transmitted from a BS using multiple beams, and a transmitter that transmits, to the BS, first feedback information that indicates at least one of a first correlation level between a pair of beams within each of beam groups and a second correlation level between a pair of the beam groups. The multiple beams are grouped into the beam groups.

One or more embodiments of the present invention may provide a new CSI/beam information feedback information for a wireless communication system adopting group based CSI/beam information feedback. Such information is beneficial to perform flexible and efficient scheduling in the BS. For example, diversity gain can be achieved by beams cycling/combination having high correlation. Quick beam recovery can be achieved by switching current beam to other beams who have low correlation with current beam.

One or more embodiments of the present invention provide multiple correlation level feedback schemes and related signaling design. The feedback framework can support flexible tradeoff between correlation level feedback accuracy, feedback overhead and latency.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIG. 2 is a diagram showing an example of a user equipment (UE) and a base station (BS) that communicate with each other using multiple beams according to one or more embodiments of the present invention.

FIG. 3 is a flowchart showing an example operation of beam group based feedback in the UE according to one or more embodiments of the present invention.

FIG. 4 is a diagram showing an example of measurement information in the UE according to one or more embodiments of the present invention.

FIG. 5A is a diagram showing an example of correlation level feedback information indicating a correlation level of each pair of beams within a beam group according to one or more embodiments of the present invention.

FIG. 5B is a diagram showing an example of the correlation level feedback information indicating the correlation level of each of pairs of beam groups according to one or more embodiments of the present invention.

FIG. 6 is a diagram showing an example of feedback mode information according to one or more embodiments of the present invention.

FIG. 7 is a diagram showing a schematic configuration of a base station (BS) according to one or more embodiments of the present invention.

FIG. 8 is a diagram showing a schematic configuration of a user equipment (UE) according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

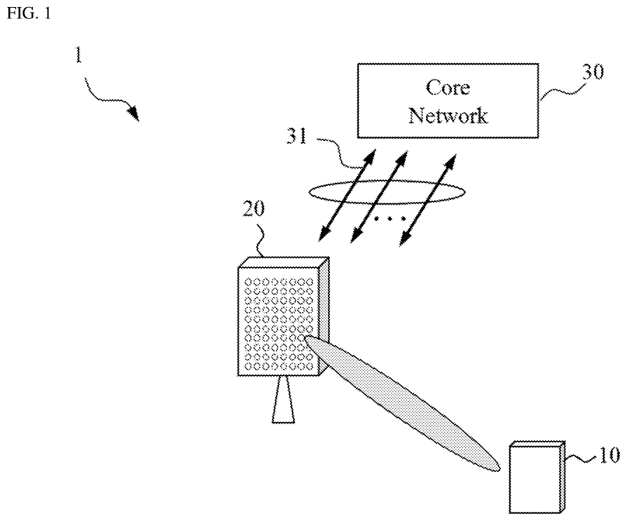

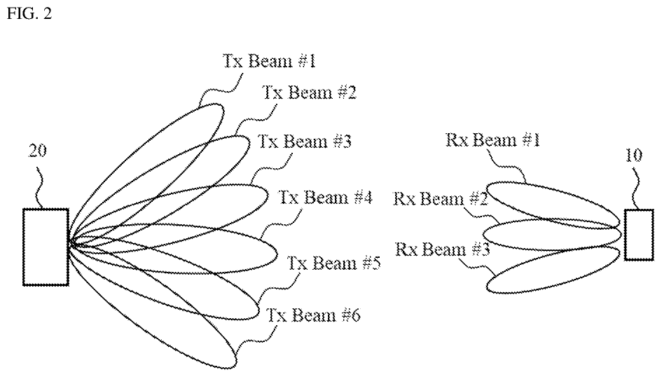

FIG. 1 is a wireless communication system 1 according to one or more embodiments of the present invention. The wireless communication system 1 includes a user equipment (UE) 10, a base station (BS) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system. In one or more embodiments, the wireless communication system 1 may be a multi-beam system where the BS 20 and the UE 10 communicate with each other using multiple beams. For example, as shown in FIG. 2, the BS 20 may use at least one multiple Tx beams (e.g., Tx beams #1-6) for transmission of downlink signals. The UE 10 may use at least one multiple Rx beams (e.g., Rx beams #1-3) for reception of downlink signals. The number of Tx and Rx beams are not limited thereto and may be one or more beams.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB).

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The UE 10 includes panels (referred to as antenna panels). RX beams within each of the panels of the UE 10 may be used for reception of downlink signals. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments, correlation between beams may indicate relative closeness of two beams. For example, beam #1 and beam #2 have good quality in measurement slot #1. In measurement slot #2, beam #1 and beam #2 have bad quality. In measurement slot #3, beam #1 and beam #2 have good quality. In such a case, beam #1 and beam #2 have high correlation because quality of beam #1 and beam #2 have similar changes over time.

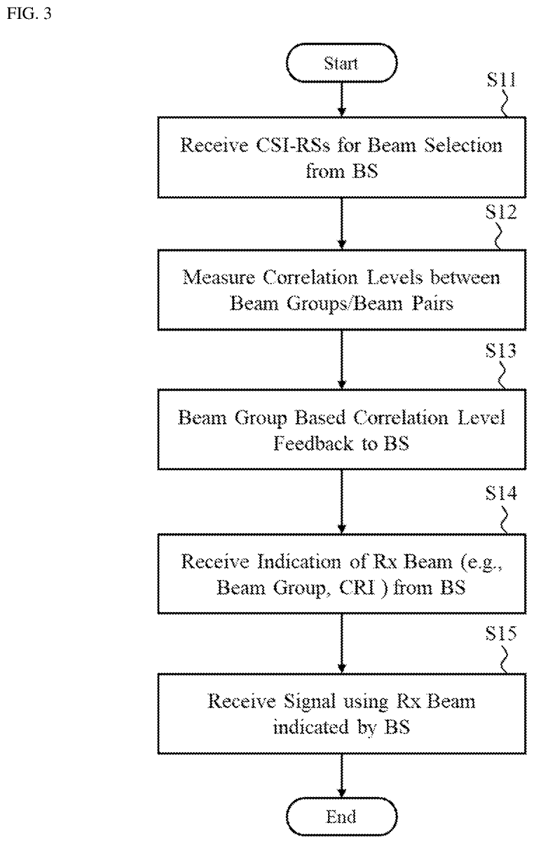

FIG. 3 is a flowchart showing an example operation of beam group based feedback in the UE 10 according to one or more embodiments of the present invention. The feedback scheme according to one or more embodiments may be referred to a beam information feedback scheme or a correlation level feedback scheme.

As shown in FIG. 3, at step S11, the UE 10 may receive multiple Channel State Information-Reference Signals (CSI-RSs) from the BS 20. The multiple CSI-RSs may be transmitted using Tx beams by the BS 20. The CSI-RSs are an example of reference signals.

At step S12, the UE 10 may measure correlation levels of beams based on the beams for the CSI-RS transmission. For example, the UE 10 may determine correlation levels based on predetermined information such as historical information. The historical information may be measurement results of quality in predetermined measurement slots.

At step S13, the UE 10 may perform beam group based feedback. For example, the UE 10 may transmit beam group based correlation level feedback information that indicates the measured correlation levels between beam groups or beam pairs. The correlation level feedback information may be transmitted as CSI feedback (CSI reporting).

At step S14, the UE 10 may receive an indication of an Rx beam from the BS 20. The indication may be indicated as a beam group index (beam group ID), a CSI-RS resource indicator (CRI), or a combination of the beam group index and the CRI. The CRI identifies each beam and may be referred to as a beam ID.

At step S15, the UE 10 may receive downlink signals using the Rx beam indicated by the BS 20.

The correlation level feedback information includes at least a flag indicator indicating pairs of beams pairs or pairs of beam groups have high correlation or low correlation. For example, one bit may be used for the flag indicate and indicate the correlation. “1” in the flag indicator denotes “High Correlated Beams (HCB)” and “0” denotes “Low Correlated Beams (LCB)”.

Another bit of the correlation level feedback information may indicate correlation levels for each of pairs of beams or each of pairs of beam groups. In one or more embodiments, the beam pairs indicate pairs within a beam group (intra-group). The pairs of beam groups indicate pairs of different beam groups (inter-group).

As another example, to reduce overhead of the correlation level feedback information, one bit may indicate whether the correlation level is high or low.

As another example, the correlation level feedback information may be indicated using multiple bits. For example, the multiple bits indicate different correlation levels. For example, “00”, “01”, “10”, and “11” denote different correlation levels indicating correlation degree that increases with the level up.

The correlation level feedback information may further include a correlation level of each pair of beams within a beam group (intra-group) and beam IDs (or CRIs) of first and second beams which are a pair of beams.

The correlation level feedback information may further include a correlation level of each of a pair of beam groups (inter-group), beam group ID (RX beam ID or equivalent) of first and second beam groups.

Furthermore, the correlation level feedback information may include both of the correlation levels of a pair of beams within a beam group (intra-group) and each of pairs of beam groups (inter-group).

Furthermore, if the UE 10 and the BS 20 acquire the correlation levels of the intra-group or the inter group between the UE 10 and the BS 20 before transmitting the correlation level feedback information, the correlation levels for the inter-group or the intra-group may be discarded.

Furthermore, if multiple beams are mutually correlated in the same level, the correlation levels of all of the beams may transmitted together from the UE 10 to the BS 20.

Furthermore, if a default correlation level (e.g., high correlation) is assumed by the BS 20 and the UE 10, exceptional cases (e.g., low correlation cases) may be reported from the UE 10 to the BS 20. The exceptional cases may include indicator of the exceptional case and a list of beam group IDs and beam IDs of pairs of beams

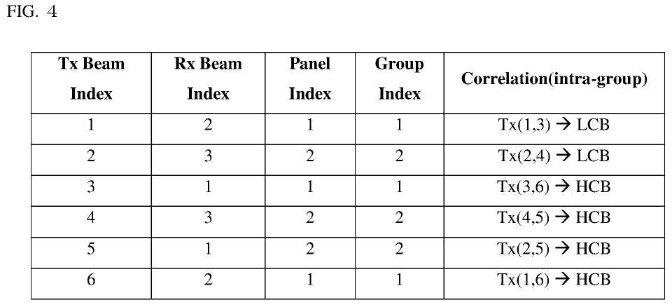

In one or more embodiments, measurement information measured by the UE 10 at the step S12 of FIG. 3 is illustrated in FIG. 4. As shown in FIG. 4, the measurement information includes a Tx beam index, an Rx beam index, and a panel index. In this example, the UE 10 has two panels. In one or more embodiments, the Tx beams are grouped in each panel of the UE 10. Accordingly, in the beam group index, Tx 1, Tx 3, and Tx 6 beams belong to Group 1 and Tx 2, Tx 4, and Tx 5 beams belong to Group 2.

The UE 10 may determine the correlation level between beams in the same group based on e.g., historical information, and then, the UE 10 may transmit the correlation level feedback information to the BS 20.

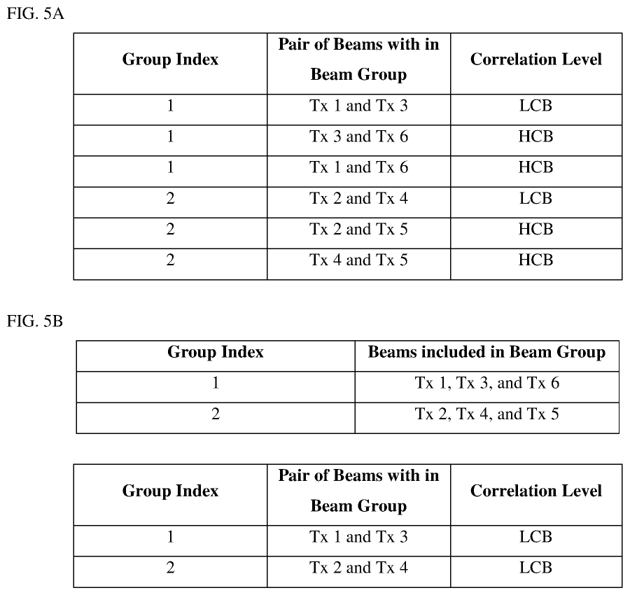

FIG. 5A is a diagram showing an example of the correlation level feedback information indicating the correlation level of each pair of beams within a beam group (intra-group) based on the measurement information of FIG. 4.

FIG. 5B is a diagram showing an example of the correlation level feedback information indicating the correlation level of each of pairs of beam groups (inter-group) based on the measurement information of FIG. 4. In an example of FIG. 5B, the UE 10 may report either LCB or HCB to the BS 20. As a result, overhead for the correlation level feedback may be reduced.

According to one or more embodiments of the present invention, feedback methods of the correlation level feedback may be changed in accordance with intra-group and inter-group.

For intra-group, the UE 10 behavior in which a pair of beams with the beam group have low correlation may be limited. For inter-group, there are Alt. 1 and Alt. 2 as follows:

In Alt. 1, the UE 10 transmits the correlation level feedback information between pairs of beam groups; and

In Alt. 2, the UE 10 behavior is limited:
In Alt. 2-1, the UE 10 behavior in which the pairs of beam groups have low correlation is limited; and
In Alt. 2-2, the UE 10 randomly selects one Rx beam set which can be considered as have low correlation with other Rx beam set.

If Alt. 1 is adopted, the UE 10 transmits the correlation level feedback information for inter-group.

If Alt. 2 is adopted, the UE 10 transmits neither correlation level feedback information for inter-group nor intra-group. The BS 20 may assume that all the beams have low correlation.

Correlation level feedback for Rx beam set based grouping system according to one or more embodiments of the present invention will be described below.

The UE 10 may transmit both the correlation level feedback information between pairs of beam groups and the correlation level feedback information between beam pairs in the same group. Similar with the above embodiments of the present invention except that indicator is needed to indicate the following correlation report is for inter group or intra group. For example, “1” denotes the correlation report is for inter group, while “0” denotes the correlation report is for intra group. The intra/inter group indicator can be jointly encoded with “HCB”/“LCB” indicator.

According to one or more embodiments of the present invention, the UE 10 may measure a correlation level based on the following methods:

(i) if the beams are transmitted by combining or beam cycling type, the UE 10 can suppose high correlation between beams;

(ii) if blockage occurred, and beam B is used as the backup beam for current beam A, the UE 10 can suppose low correlation between beam A and beam B;

(iii) if multiple beams are used for multiple rank transmission, the UE 10 can suppose that those beams are low-correlated; and

(iv) other methods are not precluded.

In one or more embodiments of the present invention, a correlation level feedback scheme for a wireless communication system will be described below. In one or more embodiments of the present invention, two different UE behaviors may be defined as:

a first method: the UE behavior explicitly specifies that the any two of the reported beams have low correlation; and

a second method: the UE 10 transmits feedback information including correlation information between any two of the reported beams (feedback design will be described in detail below).

One or more embodiments of the present invention may have different use cases.

For example, as a first use case, one or more embodiments of the present invention may be applied for beams within a beam group.

For example, as a second use case, one or more embodiments of the present invention may be applied for beams from different beam groups.

Based on combinations of the above use cases, there are the following correlation mode.

Mode 1, the UE 10 may not transmit the correlation level feedback information.

Mode 1-1: the BS 20 may assume any two beams have low correlation.

Mode 1-2: the BS 20 may not assume any correlation assumption between two beams

Mode 1-3: the BS 20 may assume any two beams have high correlation

Thus, the UE 10 may not transmit the correlation level feedback information to the BS 20 when the BS 20 assumes that the first correlation level and the second correlation level are either high or low in advance by limiting the UE behavior.

Mode 2, the UE 10 only may transmit the correlation level feedback information including the correlation level feedback information between any two beams in the same group, so that the BS 20 explicitly specifies the correlation level feedback information between two beams in the same group.

Mode 2-1: the BS 20 may assume any two beams from two different beam groups have low correlation.

Mode 2-2: the BS 20 shall not assume any correlation assumption between two beams from two different beam groups have low correlation.

Mode 2-3: the BS 20 may assume any two beams from two different beam groups have high correlation.

Mode 3, the UE 10 only may transmit the correlation level feedback information including the correlation levels between two groups, so that the BS 20 explicitly knows the correlation levels between two beams from different groups.

Mode 3-1: the BS 20 may assume any two beams from the same beam group have low correlation.

Mode 3-2: the BS 20 shall not assume any correlation assumption between two beams from the same beam group have low correlation.

Mode 3-1: the BS 20 may assume any two beams from the same beam group have high correlation.

Mode 4, the UE 10 may transmit the correlation level feedback information including both the correlation levels between pairs of beam groups and the correlation levels between beam pairs in the same group.

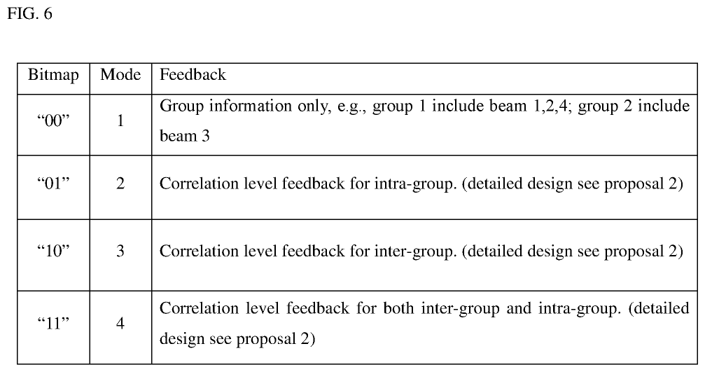

FIG. 6 is a diagram showing an example of feedback mode information according to one or more embodiments of the present invention. As shown in FIG. 6, the BS 20 may use a bitmap to configure the UE 10 with the correlation modes assumed for feedback. The feedback mode information designates information elements of the correlation level feedback information. For example, the feedback mode information designates the correlation levels between pairs of beam groups or the correlation levels between beam pairs in the same group. For example, the feedback mode information designates high correlation beams or lower correlation beams. The UE 10 may transmit the correlation level feedback information in accordance with the feedback mode information.

Another implementation is that some/all of the above mentioned mode is fixed in the specification, whereas others/no modes can be configured by the BS 20. The configuration signaling can be higher layer signaling (e.g., Radio Resource Control (RRC)) or dynamic signaling, e.g., (MAC Control Element (CE), Downlink Control Information (DCI)), or a combination of higher layer signaling and dynamic signaling.

For Mode 4, both single and multi-stage feedback may be adopted (detailed design will be described below).

The correlation feedback mode mentioned above may be down-selected.

Hybrid schemes such as schemes contained multiple modes may not preclude (detailed design will be described below).

One or more embodiments of the present invention relates to multi stage feedback for correlation feedback mode 4. In a multi-stage feedback method for mode 4, correlation levels may be fed back for both of an inter-group and an intra-group.

Alt. 1: a first stage is inter-group correlation level feedback and a second stage is intra-group correlation level feedback

Alt. 2: a first stage is intra-group correlation level feedback and a second stage is inter-group correlation level feedback

One or more embodiments of the present invention relates to hybrid schemes such as schemes contained multiple modes and related signaling design:

Hybrid scheme 1: Mode 1 (first correlation mode) and Mode 2 (second correlation mode);

Hybrid scheme 2: Mode 1 (first correlation mode) and Mode 3 (second correlation mode);

Hybrid scheme 3: Mode 1 (first correlation mode) and Mode 4 (second correlation mode).

Feedback content for each stage for one or more embodiments of the present invention:

First stage feedback (first correlation mode): group information including group ID together with the beam ID/CRI, Reference Signal Received Power (RSRP) RSRP/Channel State Information (CSI) in this group. The CSI may include a Rank Indicator (RI) and a Channel Quality Indicator (CQI).

Second stage feedback (second correlation mode): correlation level of some/all the beam pairs reported in stage 1.

For hybrid scheme 1, correlation for inter-group only

For hybrid scheme 2, correlation for intra-group only

For hybrid scheme 3, correlation for both the inter-group and intra-group.

Signaling Design:

Alt. 1: two stage feedback with predefined timeline, e.g., periodicity, time offset.

Alt. 1-1: the BS 20 uses RRC signaling to configure the UE 10 with the different parameters, e.g., periodicity, time offset for the first mode and the second mode.

Alt. 1-2: the BS 20 uses RRC signaling to configure the UE 10 with the same parameters, e.g., periodicity, time offset for the first mode and the second mode.

Alt. 2: adaptive feedback, with some or all of the feedback instances dynamically triggered.

The BS 20 uses RRC signaling to configure the UE 10 with the parameters, e.g., periodicity, time offset for the first mode.

The BS 20 uses MAC CE/DCI signaling to trigger the UE 10 for the second stage feedback.

It can be further optimized to configure the second stage feedback based on the report in the first stage feedback. For example, the BS 20 configures the UE 10 to report:

For hybrid scheme 1: inter-group correlation for selected groups. The selected groups are indicated by the BS 20 by group ID or Quasi Co-Location (QCL) information.

For hybrid scheme 2: intra-group correlation for a selected group or selected groups. The selected groups are indicated by the BS 20 by group ID or QCL information.

For hybrid scheme 3: inter-group and inter-group correlation for selected groups. The selected groups are indicated by the BS 20 by group ID or QCL information.

According to one or more embodiments of the present invention, a new CSI feedback information for group based CSI feedback system may be applied. As a result, the BS 20 may perform flexible and efficient scheduling. For example, diversity gain can be achieved by beams cycling who have high correlation. For example, quick beam recovery can be achieved by switching current beam to other beams who have low correlation with current beam.

According to one or more embodiments of the present invention, the BS 20 is able to obtain reliable channel state information/beam(s) state information to optimize beamforming and scheduling to provide high data rate, high reliability service.

According to one or more embodiments of the present invention, multiple correlation level feedback schemes and related signaling design may be introduced. The feedback framework can support flexible tradeoff between correlation level feedback accuracy, feedback overhead and latency.

In conventional methods, it was ambiguous whether beams are correlated or not. On the other hand, according to one or more embodiments of the present invention, it is possible to assume a high or low correlation level in both inter and intra groups.

(Configuration of Base Station)

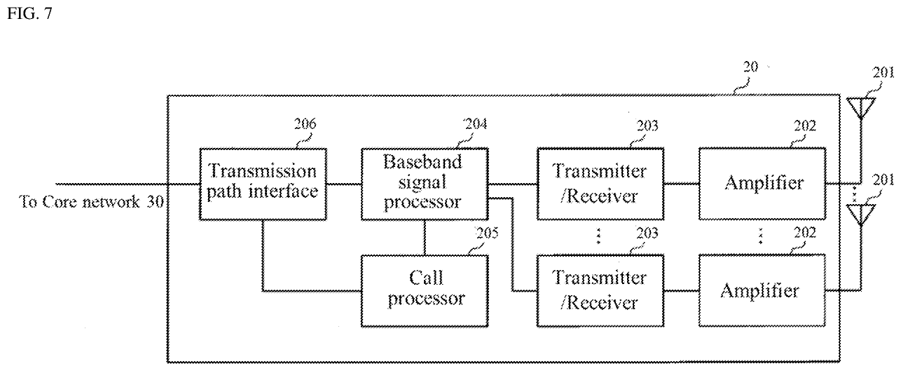

The BS 20 according to one or more embodiments of the present invention will be described below with reference to FIG. 7. FIG. 7 is a diagram illustrating a schematic configuration of the BS 20 according to one or more embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

(Configuration of User Equipment)

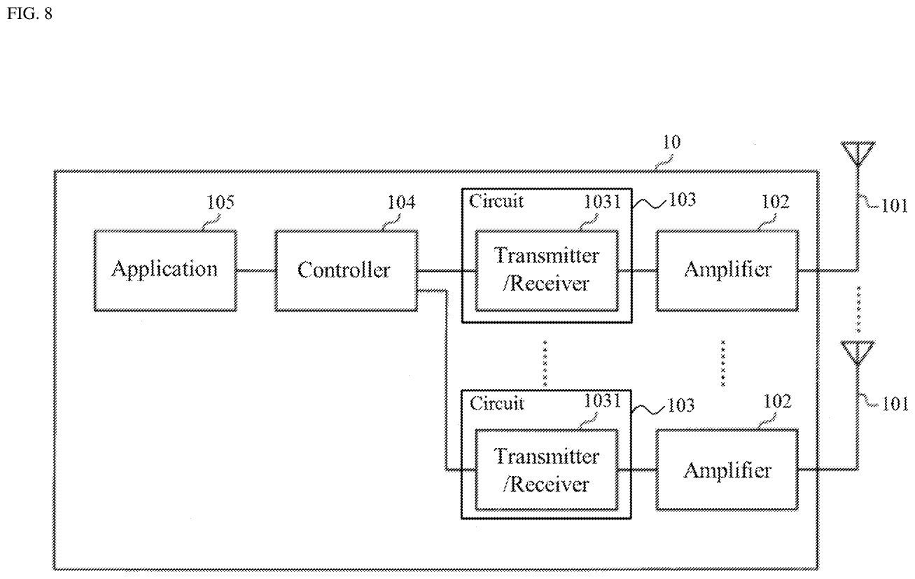

The UE 10 according to one or more embodiments of the present invention will be described below with reference to FIG. 8. FIG. 8 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

### Another Example

Although the present disclosure mainly described examples of a channel and signaling scheme based on NR, the present invention is not limited thereto. One or more embodiments of the present invention may apply to another channel and signaling scheme having the same functions as LTE/LTE-A and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method for feedback of correlation of beams in a wireless communication system, the method comprising:
transmitting, from a base station (BS) to a user equipment (UE), reference signals using multiple beams; and
transmitting, from the UE to the BS, first feedback information that indicates at least one of a first correlation level between a pair of beams within each of beam groups and a second correlation level between a pair of the beam groups,
wherein the multiple beams are grouped into the beam groups.

2. The method according to claim 1,
wherein the UE includes a plurality of antenna panels, and
wherein each of the beam groups is grouped in each of the plurality of antenna panels.

3. The method according to claim 1, wherein the first correlation level and the second correlation level are indicated as high correlation or low correlation using one bit.

4. The method according to claim 1, wherein the first feedback information includes a beam ID that identifies each of the pair of beams and a beam group ID that identifies of the pair of beam groups.

5. The method according to claim 1, wherein the first feedback information includes at least one of a Rank Indicator (RI), a Channel Quality Indicator (CQI), and a Reference Signal Received Power (RSRP) of the pair of beams and the pair of beam groups.

6. The method according to claim 1, further comprising:
transmitting, from the UE to the BS, second feedback information that indicates the first correlation level after the first feedback information indicating the second correlation level is transmitted.

7. The method according to claim 1, further comprising:
transmitting, from the BS to the UE, feedback mode information using Radio Resource Control (RRC) signaling or Downlink Control Information (DCI),
wherein the feedback mode information designates information elements of the correlation level feedback information, and
wherein the UE transmits the correlation level feedback information in accordance with the feedback mode information.

8. The method according to claim 7, wherein the feedback mode information designates the first correlation level or the second correlation level.

9. The method according to claim 7, wherein the feedback mode information designates high correlation beams or lower correlation beams as the information element included in the correlation level feedback information.

10. The method according to claim 1, wherein the UE does not transmit the first feedback information to the BS when the BS assumes that the first correlation level and the second correlation level are either high or low in advance.

11. A user equipment (UE) comprising:
a receiver that receives reference signals transmitted from a base station (BS) using multiple beams; and
a transmitter that transmits, to the BS, first feedback information that indicates at least one of a first correlation level between a pair of beams within each of beam groups and a second correlation level between a pair of the beam groups,
wherein the multiple beams are grouped into the beam groups.

12. The UE according to claim 11,
wherein the UE includes a plurality of antenna panels, and
wherein each of the beam groups is grouped in each of the plurality of antenna panels.

13. The UE according to claim 11, wherein the first correlation level and the second correlation level are indicated as high correlation or low correlation using one bit.

14. The UE according to claim 11, wherein the first feedback information includes a beam ID that identifies each of the pair of beams and a beam group ID that identifies of the pair of beam groups.

15. The UE according to claim 1, wherein the first feedback information includes at least one of a Rank Indicator (RI), a Channel Quality Indicator (CQI), and a Reference Signal Received Power (RSRP) of the pair of beams and the pair of beam groups.

16. The UE according to claim 11, further wherein the transmitter transmits, to the BS, second feedback information that indicates the first correlation level after the first feedback information indicating the second correlation level is transmitted.

17. The UE according to claim 11, further comprising:
wherein the receiver receives, from the BS, feedback mode information using Radio Resource Control (RRC) signaling or Downlink Control Information (DCI),
wherein the feedback mode information designates information elements of the correlation level feedback information, and
wherein the UE transmits the correlation level feedback information in accordance with the feedback mode information.

18. The UE according to claim 17, wherein the feedback mode information designates the first correlation level or the second correlation level.

19. The UE according to claim 17, wherein the feedback mode information designates high correlation beams or lower correlation beams as the information element included in the correlation level feedback information.

20. The UE according to claim 11, wherein the transmitter does not transmit the first feedback information to the BS when the BS assumes that the first correlation level and the second correlation level are either high or low in advance.
